(19) United States
(12) Patent Application Publication
(10) Pub. No.: US 2011/0126653 A1
(43) Pub. Date: Jun. 2, 2011

(54) ADJUSTING GEARING FOR AN ADJUSTING DEVICE OF A MOTOR VEHICLE

(76) Inventors: Gregor Kröner, Bischberg (DE); Matthias Süss, Grossheirath (DE); Jochen Hofmann, Marktgraitz (DE); Guido Neumann, Leipzig (DE); Andrea Bauersachs, Siedlerstrasse (DE)

(21) Appl. No.: 13/057,729

(22) PCT Filed: Aug. 11, 2009
(86) PCT No.: PCT/EP09/60384

§ 371 Date: Feb. 4, 2011

(30) Foreign Application Priority Data
Aug. 12, 2008 (DE) 20 2008 010 921.3

(51) Int. Cl. F16H 35/06; B23P 11/00; F16H 1/16

(52) U.S. Cl. 74/396; 29/527.1

(57) ABSTRACT

An adjusting gearing for an adjusting device of a motor vehicle is provided. The adjusting gearing having a gearing housing, having a drive input wheel which is arranged in the gearing housing and which has bearing collars formed at both sides of the drive input wheel, and having a drive output wheel which is arranged in the gearing housing and which meshes with the drive input wheel and the axis of which is aligned substantially perpendicular to the axis of the drive input wheel. The adjusting gearing further comprising a single part gearing housing having a first housing chamber for holding the drive input wheel and having a second housing chamber for holding the drive output wheel, a bearing point which is formed in the first housing chamber and which serves to hold a first bearing collar of the drive input wheel and a bearing point which is formed in the second housing chamber and which serves to hold a first bearing collar of the drive output wheel, and axially adjustable bearing bushes having cylindrical bushes, which are matched to the inner diameters of the housing chambers for centering second bearing collars of the drive input wheel and of the drive output wheel.

### CROSS-REFERENCE TO A RELATED APPLICATION

This application is a National Phase Patent Application of International Patent Application Number PCT/EP2009/060384, filed on Aug. 11, 2009, which claims priority of German Utility Model Application Number 20 2008 010 921.3, filed on Aug. 12, 2008.

### BACKGROUND

The invention relates to an adjusting gearing for an adjusting device of a motor vehicle.

Such an adjusting device is used for adjusting of two adjusting parts in a motor vehicle which are movable relatively to each other, in particular for adjusting a seat part of a motor vehicle seat, and has for this application two guide rails which extend in a longitudinal direction and are moveable relatively to each other, an adjusting gearing, a spindle and a spindle nut. The adjusting gearing is connected to one of the two guide rails, while the spindle is mounted in a first of the two guide rails and is engaged to the adjusting gearing. As in case of a pivotable spindle the adjusting gearing sets the spindle into a rotational motion or alternatively in case of a stationary spindle, a spindle nut of the adjusting gearing unrolls on the spindle, the first of the two guide rails is moved relatively to the other second guide rail and through this an adjusting part, for instance the first guide rail connected to a seat base body for a vehicle seat, is moved.

An adjusting device of the mentioned kind is known from JP 2005/06521 A in form of a so-called front drive unit, in which the adjusting gearing is arranged at the first end of the first, upper guide rail and transfers a rotational movement onto a spindle connected pivotably to the first guide rail, so that the second, lower guide rail, which engages with the spindle via a spindle nut, is moved relatively to the first guide rail. Through this relative movement of the first and second guide rails a seat part of a motor vehicle seat connected to the first guide rail can be for instance adjusted in the longitudinal direction defined by the guide rails.

In case of the adjusting gearing known from DE 10337475 A1, a spindle nut, which extends in longitudinal direction and is to be arranged on a spindle of an adjusting device, and a drive worm, which extends crosswise to the longitudinal direction, are mounted in a gearing housing. The gearing housing is separated in two symmetrical housing parts, which can be assembled and which enclose the spindle nut and the drive worm in the assembled status. The drive worm comprises an external thread, which engages via an external toothing on the spindle nut with the spindle nut and drives the adjusting gearing of the spindle nut when operated.

In case of the adjusting gearing of DE 10337475 A1 the spindle nut and the drive worm are mounted in bearing points in the gearing housing, respectively. Depending on the form of the bearing points, the spindle nut as well as the drive worm can hereby have a certain clearance relatively to the gearing housing, which is caused by tolerances in the formation of the gearing housing and/or the spindle nut or the drive worm, and which is of disadvantage when operating the adjusting gearing. If the spindle nut has in particular a clearance in longitudinal direction, which corresponds to the axial direction of the spindle interacting under operation with the spindle nut, this leads to an insufficient mounting of the adjusting part which is to be adjusted by the adjusting gearing, for instance a vehicle seat, which is in this case exemplarily hold by the adjusting gearing and can move when operating the motor vehicle, in particular in case of a load reversal of the vehicle (breaking, starting) relatively to the adjusting gearing and therefore to the adjusting direction. This is on the one hand unpleasant for an occupant and secondly leads to the development of noise (rattling).

When operating the adjusting gearing, an undesired noise development can also occur in case of change of direction of the adjusting devices, namely when changing the moving direction while adjusting, due to an exemplarily mounting of the drive worm in the gearing housing and the hitting of the drive worm on the one or the other side of the gearing housing.

Furthermore, the assembly of the adjusting gearing composed of the two housing halves and four bearing plates for bearing the drive worm of the spindle nut is elaborated, in particular when considering the previously mentioned problems in respect to the bearing clearing and the noise development resulting there from and insufficient adjustment of the adjusting parts of the adjusting device being movable relatively to each other, which requires an elaborate positioning of the bearing points in respect to the toothing elements.

### SUMMARY

The object of the present invention is to provide an adjusting gearing which can be obtained by simple means and an easy assembly, which guarantees essentially a clearance-free mounting of a drive-input wheel connected to a driving device, for instance a drive worm, and a drive output wheel, for instance a spindle nut or a screw gear.

According to an exemplary embodiment of the invention the adjusting gearing comprises a one-piece gearing housing with a first housing chamber for holding a drive input wheel with bearing collars formed at both sides of the drive input wheel, a second housing chamber for holding a drive output wheel, which meshes with the drive input wheel and which has bearing collars formed on both sides of the output wheel, and the axis thereof is aligned essentially perpendicular to the axis of the drive input wheel, bearing points formed in the first and second housing chamber for holding a first bearing collar of the drive input wheel and a first bearing collar of the drive output wheel and axially adjustable bearing bushes with cylindrical bushes which are matched to the inner diameters of the housing chambers for centering the second bearing collars of the drive input wheel and the drive output wheel.

The adjusting gearing according to the invention guarantees with simple production and assembly a clearance-free arrangement of the drive input wheel or the drive worm and the drive output wheel or the spindle nut or the screw gear in a one-piece gearing housing with bearing points formed at the one end of the housing chamber for holding the one bearing collars of the drive input and drive output wheel so that the housing chambers have a basin shaped form or pot form with a central bore for holding the one bearing collar of the drive input and drive output wheels.

By assigning of the housing chambers extending in X- and Y-direction, that means perpendicular to each other, in that direction of the motor vehicle with an opening provided in the intersection, a radial clearance-free toothing engagement between the drive input wheel and the drive output wheel is guaranteed, while the bearing bushes which hold and centre the other bearing collars of the drive input wheel and the drive output wheel are axially positioned such and connected to the front face of the respective housing chamber so that no axial play occurs.

In this connection play-free means that the play in axial direction between the drive input wheel or a drive worm and the gearing housing and between the drive output wheel or a spindle nut or a screw gear and the gearing housing is minimized or eliminated. The drive input wheel (drive worm) and the drive output wheel (spindle nut or screw gear) are mounted axially free of play in the gearing housing, can however simultaneously be freely rotated around their axis. Free of play can also be understood in this connection that the play is adjusted during the assembly in a desired, defined manner.

The essential advantage of the method according to the invention consists therein that by specifying the one bearing point for the one bearing collar of the drive input wheel and drive output wheel the axial play of the drive input wheel and the drive output wheel can be adjusted simply by the axial positioning of the bearing bushes holding the other bearing collars and can be eliminated through this. The toothing engagement of the drive input wheel and the drive output wheel determined by the distance of the housing chambers of the one piece gearing housing in Z-direction determines that the distance of the axis in vertical direction between the spindle nut or the screw gear and the drive worm is minimised or adjusted in the desired manner.

The solution according to the invention allows therefore in total for a short tolerance chain as well as a clearance compensation for all toothing parts of the adjusting gearing which can be integrated into an assembly process.

In an exemplary embodiment the axial adjustable bearing bushes comprise a flange which is connected to the cylindrical bushes centering the drive input wheel and the drive output wheel, whereby the flange rests against the front faces of the housing chambers in the assembled status of the adjusting gearing.

In this embodiment, the cylindrical bushes allow the centering of the drive input and drive output wheel as well as the compensation for play in axial direction, while the flange connected to the cylindrical bushes serves after the assembly of the bearing bushes for fixing the bearing bushes on the housing chamber of the bearing housing, whereby the connection of the bearing bushes being axial adjustable to the housing chambers occurs preferably firmly bonded, in particular via adhesive or welding joint.

In a further exemplary embodiment the axial adjustable bearing bushes comprise a thread structure, which serves to obtain a larger joint face in particular for adhesive joint with the housing chambers and for increasing the increasing the reception of actual forces.

In a first modification of the adjusting gearing the drive input wheel consists of a drive worm, which is connected via drive shaft to a driving device, while the drive output wheel is formed as a spindle nut, whereby the external toothing thereof meshes with the drive worm and comprises an internal bore extending in axial direction, said bore has an internal toothing in form of worm thread, said thread engages with a spindle such that the spindle nut driven by the drive worm unrolls on the spindle and moves along the spindle.

This embodiment is used in a preferred application for an adjusting device for adjusting seat parts of a motor vehicle seat with two guide rails being relatively adjustable to each other, of which the one guide rail is connected to the adjusting gearing comprising the spindle nut, while a spindle being operatively connected to the spindle nut of the adjusting gearing rests against the other guide rail.

In a second embodiment designated as “front drive unit”, the drive input wheel consists of a drive worm, which is connected via a drive shaft to a driving device, while the drive output wheel is formed as a screw gear, which is tightly connected to a spindle mounted rotatably at a first adjusting part of the adjusting device and rotates the spindle by actuation of the driving device and a second adjusting part adjustable relatively to the first adjusting part of an adjusting device, which is connected to a spindle nut meshing with the spindle, which unrolls on the spindle being set into a rotational movement by the adjusting gearing such that the first adjusting part of the adjusting device is adjusted relatively to the second adjusting part of the adjusting device.

This embodiment is preferably employed in an adjusting device for adjusting seat parts of a motor vehicle seat with two guide rails being relatively adjustable to each other, of which the one guide rail is connected to the adjusting gearing containing the screw gear and which stores the spindle which is tightly connected to the screw gear while the other guide rail is connected to a spindle nut, which meshes with the spindle, and which is moved along the spindle when actuating the driving device and thus the spindle set into a rotational movement by said actuating.

In both embodiments, the spindle nut or the screw gear comprise a cylindrical contour continuing in longitudinal direction of the spindle with a surface formed as a cylinder jacket, whereby in said surface the external toothing of the spindle nut or the screw gear formed in radial direction vertical to the longitudinal extension of the spindle nut or the screw gear inwards into the spindle nut or the screw gear is worked into, adjacent to which in axial direction two free sections are formed, which are followed axially a bearing collar (61, 62), respectively.

Due to the formation of two cylindrical housing chambers being aligned vertical to each other in the bearing housing, of which the first housing chamber holds the drive worm, and which is aligned in Y-direction of the motor vehicle and arranged above the second housing chamber, which holds the spindle nut or the screw gear and which is aligned in X-direction of the motor vehicle, whereby within an opening provided in the area of cross-section between the housing chambers the toothing of the drive worm and the spindle nut or the screw gear mesh with each other, the distance between the first and the second housing chamber in said direction of the motor vehicle determines the toothing engagement of the toothing or formed as worm toothing of the drive worm and the spindle nut or the screw gear so that it is guaranteed by the geometry of the gearing housing, that the drive worm and the spindle nut or the screw gear match with each other essentially with a play.

This embodiment of the gearing housing does not only determines the toothing engagement of the drive worm and the spindle nut or the screw gear in a defined manner and therefore provides the required freedom of play, but simultaneously simplifies considerably the assembly and due to the formation of the bearing points at the one front faces of the gearing housing as well as due to the mounting of the bearing bushes at the other front faces of the housing chambers, it is guaranteed that also in case of a longer application a centering of the drive worm and the spindle nut or the screw gear and therefore a correct, play-free toothing engagement is maintained.

A third tubular like-housing chamber is provided for connecting the gearing housing to an adjusting part of the adjusting device, whereby said housing chamber holds a connecting pin connected to the one adjusting part of the adjusting device and is preferably arranged beside the first housing chamber and is aligned parallel to said first housing chamber.

A reinforcing rib, which encloses the first housing chamber and the third, tubular like-housing chamber and which is essentially aligned in X-direction and leads to the end of the second housing chamber, is provided for increasing the stability of the bearing housing.

The sides of the second housing chamber are aligned flush with the end of the first and the third housing chamber in a flattened manner.

The production of the gearing housing from plastics guarantees on the one hand a lower weight of the adjusting gearing and simplifies on the other hand the assembly of the gearing housing either by a connection of the housing chambers and the bearing points which are connected to the first and second housing chamber and which are formed on the one front faces of the first and the second housing chamber by means of adhesion, friction welding, laser welding or laser melt welding, or alternatively by die-casting or injection moulding of the plastics.

A method for assembling the adjusting gearing is characterized in that
a one-piece gearing housing with two cylindrical housing chambers being aligned vertical to each other and with bearing points formed on the one front faces with a centrical bore is obtained by dye casting or injection moulding of a plastic or by connecting the housing chambers by means of laser welding, ultrasound welding, vibration welding, adhesion, hot embossing or welding with inductive heating,
a first bearing collar of a drive worm is inserted into the bearing point of the first housing chamber and a first bearing collar of a spindle nut or a screw gear is inserted into the bearing point of the second housing chamber,
a first bearing bush having a cylindrical bush that matches to the inner diameter of the first housing chamber is inserted for centering the second bearing collar of the drive worm and a second bearing bush having a cylindrical bush that matches the internal diameter of the second housing chamber is inserted for centering the second bearing collar of the spindle nut or the screw gear into the first and second housing chamber and mounted onto the second bearing collar of the drive worm or the spindle nut or the screw gear until a play-free mounting of the drive worm or the spindle nut or the screw gear,
and the first and the second bearing bush are connected to the first and second housing chamber by laser welding, ultrasound welding, vibration welding, adhesion, hot embossing or welding with inductive heating.

### BRIEF DESCRIPTION OF THE DRAWINGS

The object of the invention and the idea on which the invention is based on shall be explained in more detail in the following by means of an embodiment shown in the drawing.

FIG. 1 shows an adjusting gearing for an adjusting device for adjusting an adjusting part in a motor vehicle in an explosive illustration.

FIG. 2 shows a schematic perspective view of the assembled adjusting gearing according to FIG. 1.

FIG. 3 shows a perspective explosive illustration of an adjusting device with an adjusting gearing.

### DETAILED DESCRIPTION

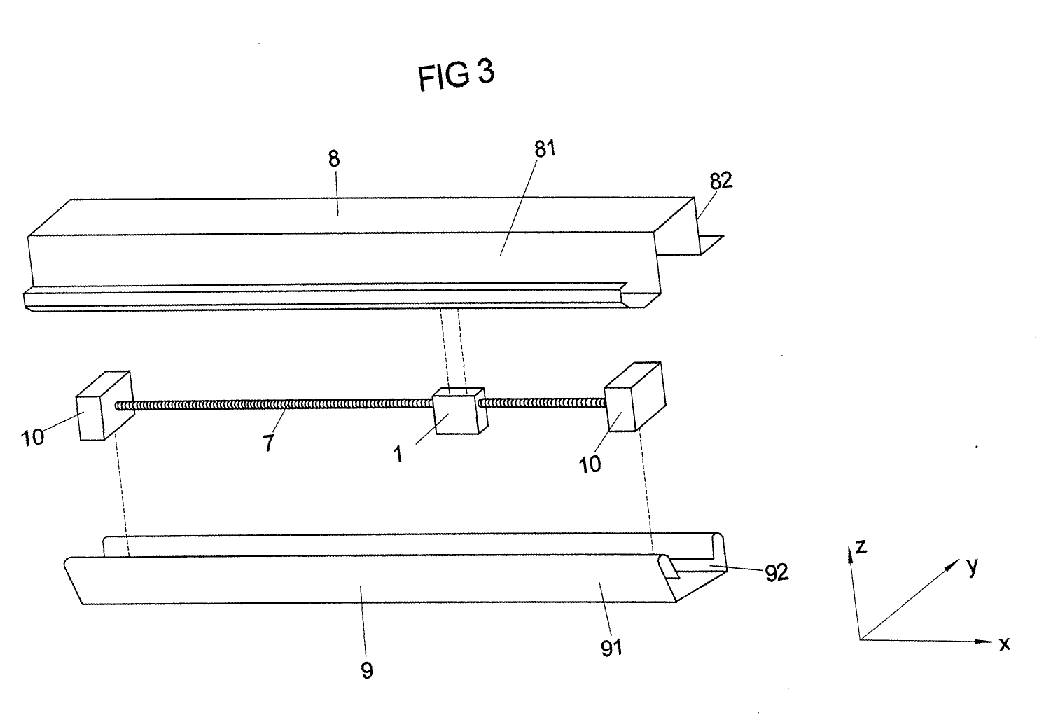

FIG. 3 shows an adjusting gearing for adjusting an adjusting part, for instance a seat part of a motor vehicle seat. The adjusting device has a first guide rail 8 and a second guide rail 9 as well as spindle drive, which is formed by a spindle 7 and an adjusting gearing 1. The adjusting part can hereby be connected to the first guide rail 8 and is moved by a movement of the first guide rail 8 relatively to the second guide rail 9 by the spindle drives.

In case of the spindle drive shown in FIG. 3 the adjusting gearing 1 is arranged at the first guide rail 8, is engaged with the spindle 7 and moves during adjustment together with the first guide rail 8 along the spindle 7, which is connected via mounting blocks torque proof to the second guide rail 9. The spindle 7 comprises an outside thread, which interacts with an inside thread of a spindle nut of the adjusting gearing 1, and transfers a rotational movement of the spindle nut in a longitudinal movement of the adjusting gearing 1 along the spindle 7 and therefore on the first guide rail 8 which is connected to the adjusting gearing 1 relatively to the second guide rail 9.

The adjusting device can be alternatively designed as a so called “front drive unit” in which a screw gear is provided instead of a spindle nut, said screw gear is tightly connected to a spindle 7, which is rotatably arranged at the first guide rail 8 and sets the spindle 7 into a rotational movement. In this case, a spindle nut is arranged at the second guide rail 9, whereby said spindle nut unrolls on the spindle 7, which was set into a rotational movement by the adjusting gearing 1, and effects therefore, that the first guide rail 8 is adjusted relatively to the second guide rail 9. In such an arrangement the spindle 7 is thus rotatably connected to the first guide rail 8 and is driven by the screw gear of the adjusting gearing 1, while a spindle nut is arranged torque proof at the second guide rail 9.

The first guide rail 8 and the second guide rail 9 are formed in each case U-shaped in cross section vertical to the longitudinal direction of extension, whereby the first guide rail 8 is bent outwards on the edges of the legs 81, 82 and the second guide rail 9 is bent inwards on the edges of the legs 91, 92 thereof such that the first guide rail 8 is mounted for instance via rolling elements gliding in longitudinal direction, which corresponds in the assembled status to the X-direction of a motor vehicle, is mounted in the second guide rail 9 and is guided along the second guide rail 9. The adjusting gearing 1 arranged at the first guide rail 8 moves along the spindle 7 for adjustment of the first guide rail 8 relatively to the second guide rail 9.

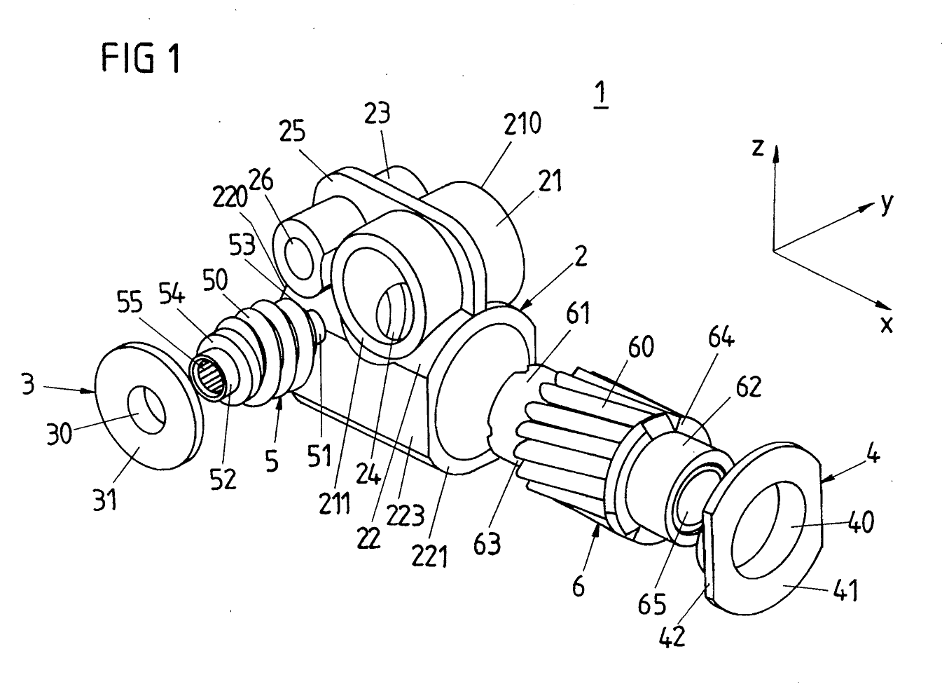

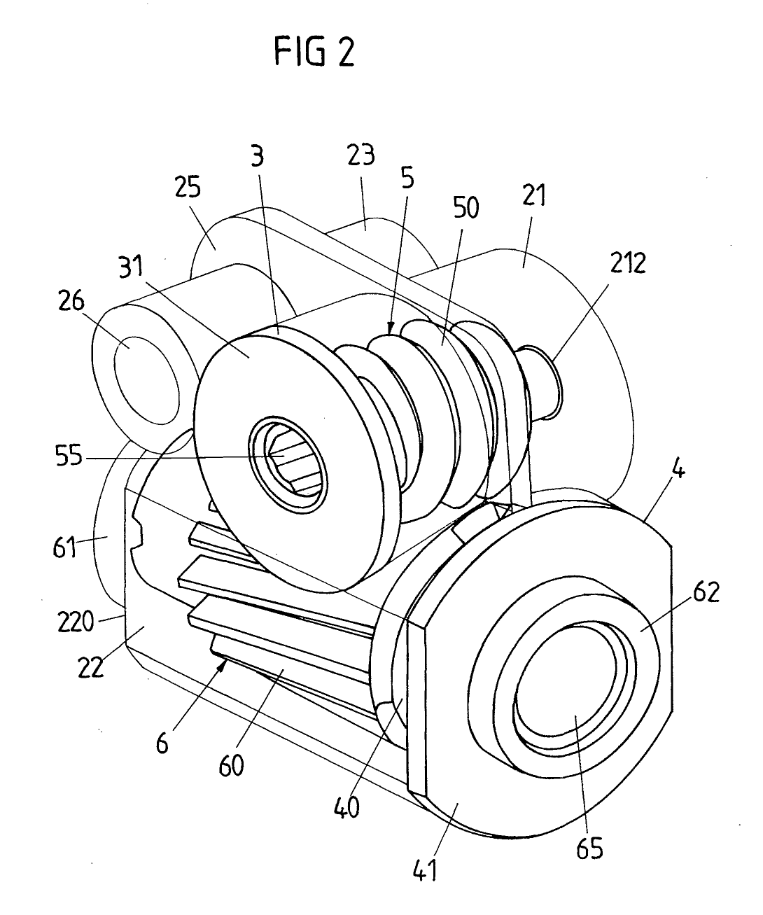

The adjusting gearing 1 shown in FIG. 1 in an explosive illustration and in FIG. 2 in the assembled status comprises a one-piece gearing housing 2 with two cylindrical housing chambers 21, 22 which are aligned vertically to each other and arranged above each other. In order to employ in an adjusting device for adjusting a seat part of a vehicle seat with two guide rails 8, 9, which are guided into one another and are movable relatively to each other according to the principle illustration of FIG. 3, the one-piece gearing housing 2 is connected to the first guide rail 8 such that the first housing chamber 21 is aligned in Y-direction of the motor vehicle and the second housing chamber 22 is aligned in flush with the spindle 7 according to FIG. 3 in X-direction of the motor vehicle.

On the one front face 210 of the first housing chamber 21 and the one front face 220 on the second housing chamber 22 bearing points with a central opening are provided of which in FIG. 2 the bearing point with central opening 212 of the first housing chamber 21 is recognizable. The bearing points with central opening are for instance formed as bores or cylinder bushes on the one front face 210, 220 of the first and second housing chamber 21, 22 and consists of cylinder bushes, which are connected to the cylindrical wall of the first and second housing chamber 21, 22 via spokes extending radially from the bearing bushes. Through this, a tank or pot-shape of the housing chambers 21, 22 with a central bore is provided for holding of bearing collars of a drive input and drive output wheel.

The distance of the central longitudinal axis of the first housing chamber 21 from the central longitudinal axis of the second housing chamber 22 in Z-direction is smaller than the sum of the internal radius of the two housing chambers 21, 22 so that an intersecting plane is provided in which an opening 24 is formed between the two housing chambers 21, 22.

Furthermore, the one-piece gearing housing 2 comprises a third, tubular-like housing chamber 23 through which a connecting pin can be inserted and which is tightly connected to the one adjusting part, for instance the first guide rail 8 according to FIG. 3. In order to increase the stability of the one piece gearing housing 2 a re-enforcing rib 25 which encloses the first and the third housing chamber 21, 23, which is aligned in X-direction and ends at the second housing chamber 22 is provided, which serves the stabilisation of the gearing housing 2 for receiving of adjusting forces, in particular if the one piece gearing housing 2 is made of plastics in die-casting or injection molding.

A drive worm is inserted into the first housing chamber 21 according to FIG. 1, said drive worm comprises a bore 55 for connecting to a drive shaft of a preferably electromotive driving device, a worm toothing 50, two toothing free sections 53, 54 adjacent to the worm toothing 50 and bearing collars 51, 52 which are attached to said sections, said bearing collars comprise a surface formed as a cylinder jacket, whereby the external diameter of the bearing collars 51, 52 is smaller than the diameter of the toothing free sections 53, 54 so that a stepped profile of the drive worm 5 is provided in longitudinal direction.

A screw gear 6 with a longitudinal bore 65 is inserted into the second housing chamber 22 whereby in said bore a spindle 7 according to FIG. 3 is inserted and tightly connected to the screw gear 6. The screw gear 6 comprises an external toothing 60 which meshes in the area of the opening 24 between the two housing chambers 21, 22 with the worm toothing 50 of the drive worm 5. The external toothing 60 descends on both sides into toothing free sections 63, 64 onto which two bearing collars 61, 62 are attached, which comprise a surface formed as a cylinder jacket, whereby the external diameter of the bearing collars 61, 62 is smaller than the diameter of the toothing free sections 63, 64 so that a stepped profile of the screw gear 6 is provided in longitudinal direction.

The distance between the first housing chamber 21 and the second housing chamber 22 in Z-direction and therefore the distance of the longitudinal axis of the drive worm 5 and the screw gear 6 in relation to the formation of the worm toothing 50 and the external toothing 60 is measured such that the worm toothing 50 of the drive worm meshes play-free with the external toothing 60 of the screw gear 6.

A spindle nut can be provided alternatively to a screw gear 6 tightly connected to the spindle 7, wherein said spindle nut comprises an internal bore 65 extending in longitudinal direction, said bore is provided with an internal toothing in form of the worm thread and is engaged with the spindle 7 (FIG. 3) when operating the adjusting gearing 1. The spindle nut 6 unrolls via the internal toothing in the bore 65 on the spindle 7 driven via the drive worm 5, moves along the spindle 7 and effects there through a relative movement between the adjusting gearing connected to the one adjusting part and the spindle 7 connected to the other adjusting part.

The bearing points on the one front faces 210, 220 of the two housing chambers 21, 22, which serve for holding in each case a first bearing collar 51 of the drive worm 5 or a first bearing collar 61 of the screw gear 6, are dimensioned such that both bearing collars 51, 61 are mounted play-free, but without hindrance of a rotational movement of the drive worm 5 and the screw gear 6 in the bearing points.

In order to guarantee a reliable operation and to avoid an undesired noise development when operating the adjusting gearing 1 it is essential that the drive worm 5 as well as the spindle nut or the screw gear 6 are mounted radially and axially play-free in the gearing housing 2. Hereby it is in particular of importance to minimize the play of the spindle nut or the screw gear 6 in longitudinal direction (X direction of the motor vehicle) in order to avoid a relative movement of the guide rails 8, 9 towards each other, in particular by load reversal (braking or starting) of the vehicle and clapping noises resulting therefrom. Furthermore, the play of the drive worm 5 in axial direction thereof is also to be suppressed as far as possible in order to avoid a noise development when operating the adjusting device, in particular during shifting from a forward into a backward movement. Such a noise development results therefrom that in case of an axial play between the drive worm 5 and the gearing housing 2 the spindle nut or the screw gear 6 strikes when moving the adjusting device in an adjusting direction (parallel to the longitudinal direction X) against the one side of the gearing housing 2 and moves by reversal of a moving direction to the other side of the gearing housing 2 and strikes against the other side.

During assembling of the adjusting gearing 1 according to the invention the drive worm 5 is inserted into the first housing chamber 21 and is inserted with a bearing collar 51 thereof into the bearing point 210 provided at the front face 28 of the first housing chamber 21 until the front face of the toothing free section 53 rests against the bearing point 210. In an analogue manner the screw gear 6 is inserted into the second housing chamber 22 until the one bearing collar 61 of the screw gear 6 engages with the bearing point provided at the front face 220 of the second housing chamber 22 and rests against the bearing point with the inner front face of the toothing free section 63.

A first bearing bush 3 is inserted into the open front face 211 of the first housing chamber 21 after inserting the drive worm 5 into the first housing chamber 21. The first bearing bush 3 comprises a cylindrical bush 30, the cylindrical surface thereof corresponds to the internal diameter of the first housing chamber 21 and the cylindrical bore thereof corresponds to the external diameter of the other bearing bush 52 of the drive worm 5 so that the first bearing bush 3 centres after the mounting on the other bearing collar 52 of a drive worm 5 the drive worm towards the first housing chamber 21.

In analogy, a second bearing bush 4 is inserted into the open front face 221 of the second housing chamber 22 after the insertion of the one bearing collar 61 of the screw gear 6 into the bearing point of the second housing chamber 22. The second bearing bush 4 comprises a cylindrical bush 40, the cylindrical surface thereof corresponds to the internal diameter of the second housing chamber 22 and the cylindrical bore thereof corresponds to the external diameter of the other bearing collar 62 of the spindle nut or the screw gear 6 so that the second bearing bush 4 centres the spindle nut or the screw gear 6 of the second housing chamber 22 after inserting said bush into the second housing chamber 22 and mounting on the other bearing collar 62.

The axial length of the bearing bushes 3, 4 or the cylindrical bushes 30, 40 is measured such that a sufficient axial movement of the cylindrical bushes 30, 40 into the housing chambers 21, 22 is possible in order to mount the drive worm 5 as well as the spindle nut or the screw gear 6 in axial direction play-free in the gearing housing 2.

Flanges 31, 41 are formed on the end sides of the cylindrical bushes 30, 40 of the bearing bushes 3, 4, the external diameter of said flanges is adapted to the form and the external diameter of the first or the second housing chamber 21 or 22.

After inserting the drive worm 5 into the first housing chamber 21 until the toothing free section 53 of the drive worm 5 rests against the first front face 210 of the first housing chamber 21 with the bearing point 212 the first bearing bush 3 is inserted into the second front face 211 of the first housing chamber 21 and thereby the cylindrical bush 30 of the first bearing bush 3 is adjusted in Y-direction so far until the front face end of the cylindrical bush 30 rests against the front face of the toothing free section 53 of the drive worm 5 so that no axial play of the drive worm 5 in the first housing chamber 21 of the gearing housing 2 is provided without that thereby the rotational movement of the drive worm 5 is hindered.

In an analogue manner after inserting the spindle nut or the screw gear 6 into the second housing chamber 22 until the toothing free section 63 of the spindle nut or the screw gear 6 rests against the first front face 220 of the second housing chamber 22 the second bearing bush 4 is inserted into the second front face 221 of the second housing chamber 22 and thereby the cylindrical bush 40 of the second bearing bush 4 is adjusted in X-direction so far until the front face end of the cylindrical bush 40 rests against the front face of the toothing free sections 63 of the spindle nut or the screw gear 6 so that no axial play of the spindle nut or the screw gear 6 is provided in the second housing chamber 22 of the gearing housing 2 without that the rotational movement of the spindle nut or the screw gear 6 is hindered.

After the corresponding positioning of the bearing bushes 3, 4 the flanges 31, 42 of the bearing bushes 3, 4 are connected by laser welding, ultrasound welding, vibration welding, adhesion, hot embossing or welding with inductive heating to the second front face 211, 221 of the first and second housing chamber 21, 22 of the gearing housing 2, and hereby a lasting play-free mounting of the drive worm 5 and the spindle nut or the screw gear 6 in the gearing housing 2 is guaranteed.

FIG. 2 shows the finally assembled adjusting gearing 1 with an axial play-free mounting of the drive worm 5 and the spindle nut or the screw gear 6 as well with play-free toothing engagement of the toothing of the drive worm 5 into the toothing of the spindle nut or the screw gear 6 through the axial distance of the centre longitudinal axis of the drive worm 5 from the centre longitudinal axis of the spindle nut or the screw gear 6 or through the axial distance of the centre longitudinal axis of the first housing chamber 21 from the centre longitudinal axis of the second housing chamber 22. In the such assembled status of the adjusting gearing 1 a connecting pin is inserted through the bore 26 of the third, tubular-like housing chamber 23 and is connected to one of the two adjusting parts of the adjusting device so that a connection of the adjusting gearing 1 to the corresponding adjusting part of the adjusting device is provided.

The embodiment shown in FIGS. 1 and 2 relates to a front drive unit with a screw gear which is tightly connected to a spindle, whereby the spindle meshes with a spindle nut, which is connected to the one of the two adjusting parts of the adjusting device, while the spindle with the adjusting gearing is connected to the other of the two adjusting parts of the adjusting gearing. Alternatively, the spindle nut can be provided instead of the screw gear, whereby the internal toothing of the spindle nut meshes with the toothing of a spindle, which is connected with the one of the two adjusting parts of an adjusting device, while the adjusting gearing with the drive worm and the spindle is connected via the connecting pin to the other of the two adjusting parts of the adjusting device.

The gearing housing 2, the bearing bushes 3, 4, the drive worm 5 and the spindle nut or the screw gear 6 of the adjusting gearing 1 consist preferably of plastic in order to obtain a light and inexpensive mounting form of the adjusting gearing 2 and to simplify the assembly, in particular the adjustment of the freedom of play by axially aligning the bearing bushes 3, 4 and the connection thereof to the housing chambers 21, 22.

In order to minimize the lateral dimensions of the adjusting gearing 1 and to allow contact surfaces at the one adjusting part of the adjusting device the sides of the second housing chamber 22 are flattened and aligned flush at the front faces 210, 211 of the first housing chamber 21.

1-21. (canceled)

22. An adjusting gearing for an adjusting device of a motor vehicle having a gearing housing, having a drive input wheel which is arranged in the gearing housing and has bearing collars formed at both sides of the drive input wheel, and having a drive output wheel which is arranged in the gearing housing and which meshes with the drive input wheel and the axis of which is aligned substantially perpendicular to the axis of the drive input wheel, further comprising
a single part gearing housing having a first housing chamber for holding the drive input wheel and having a second housing chamber for holding the drive output wheel,
a bearing point which is formed in the first housing chamber and which serves to hold a first bearing collar of the drive input wheel and a bearing point which is formed in the second housing chamber and which serves to hold a first bearing collar of the drive output wheel and
axially adjustable bearing bushes having cylindrical bushes, which are matched to the inner diameters of the housing chambers for centering of second bearing collars of the drive input wheel and the drive output wheel.

23. The adjusting gearing according to claim 22, wherein the axially adjustable bearing bushes comprise a flange which is connected to the cylindrical bushes, whereby the flange rests against the open front faces in the assembled status of the adjusting gearing.

24. The adjusting gearing according to claim 22, wherein the axially adjustable bearing bushes can be firmly bonded to the housing chambers.

25. The adjusting gearing according to claim 24, comprising an adhesive bond of the axially adjustable bearing bushes to the housing chambers.

26. The adjusting gearing according to claim 24, comprising a welded joint of the axially adjustable bearing bushes to the housing chambers.

27. The adjusting gearing according to claim 26, wherein the flange of the axially adjustable bearing bushes can be firmly bonded to the housing chambers, in particular by the means of laser welding, ultrasound welding, vibration welding, adhering, hot embossing or welding with inductive heating.

28. The adjusting gearing according to claim 22, wherein the axially adjustable bearing bushes (3, 4) have a thread structure.

29. The adjusting gearing according to claim 22, wherein the drive input wheel consists of a drive worm, which is connected to a driving device via a drive shaft, and wherein the drive output wheel is formed as a spindle nut, the external toothing thereof meshes with the worm toothing of the drive worm and which comprises a longitudinal bore extending in axial direction, which is supplied with an internal toothing in form of a worm thread, which engages with spindle such that the spindle nut driven by the drive worm unrolls on the spindle and moves along the spindle.

30. The adjusting gearing according to claim 22, wherein the drive input wheel consists of a drive worm, which is connected to a driving device via a drive shaft, and wherein the drive output wheel is formed as a screw gear, which is tightly connected to a spindle, which is pivoted on a first adjusting part of the adjusting device, and rotates the spindle when actuating the driving device and a second adjusting part, which can be adjusted relatively to the first adjusting part of the adjusting device, is connected to the spindle nut, which meshes the spindle, and which unrolls on the spindle, which has been put into a rotational movement by the adjusting gearing, such that the first adjusting part of the adjusting device is adjusted relatively to the second adjusting part of the adjusting device.

31. The adjusting gearing according to claim 29, wherein the spindle nut has a cylindrical contour continuing in a longitudinal direction of the spindle (7) with a surface formed as a cylindrical jacket, whereby in said surface the external toothing of the spindle nut is worked into, whereby said toothing is formed in radial direction perpendicular to the longitudinal extension of the spindle nut inwards into the spindle nut, whereby adjacent to said toothing in axial direction toothing-free sections are formed, to which axially a respective bearing collar is attached.

32. The adjusting gearing according to claim 30, wherein the screw gear has a cylindrical contour continuing in a longitudinal direction of the spindle with a surface formed as a cylindrical jacket, whereby in said surface the external toothing of the screw gear is worked into, whereby said toothing is formed in radial direction perpendicular to the longitudinal extension of the screw gear inwards into the screw gear, whereby adjacent to said toothing in axial direction toothing-free sections are formed, to which axially a respective bearing collar is attached.

33. The adjusting gear according to claim 29 for an adjusting device for adjusting seat parts of a motor vehicle seat with two guide rails being adjustable relatively to each other of which the one guide rail is connected to the adjusting gearing having the spindle nut, while the spindle which is being operatively connected to the spindle nut of the adjusting gearing rests against the other guide rail.

34. The adjusting gearing according to claim 30 for an adjusting equipment for adjusting of seat parts of a motor vehicle seat with two guide rails being adjustable relatively to each other, of which the one guide rail is connected to the adjusting gearing containing the screw gear and which stores the spindle firmly connected to the screw gear, while the other guide rail is connected to a spindle nut which meshes using the spindle, which is moved along the spindle when actuating the driving device and the spindle set therefore into a rotational motion.

35. The adjusting gearing according to claim 22, wherein the gearing housing has two cylindrical housing chambers being aligned perpendicular to one another, of which a first housing chamber holds the drive worm and above which the second housing chamber holding the spindle nut or the screw gear is arranged, and that in the area of the interface between the housing chambers an opening is provided inside which the toothing of the drive worm and the spindle nut or screw gear mesh with each other.

36. The adjusting gearing according to claim 35, wherein the first housing chamber is aligned in Y-direction of the motor vehicle and the second housing chamber is aligned in X-direction of the motor vehicle with the gearing housing being connected to the adjusting device, and that the distance of the first housing chamber from the second housing chamber in Z-direction of the motor vehicle is determined such that the toothings of the drive worm and the spindle nut or the screw gear mesh essentially with each other free of play.

37. The adjusting gearing according to claim 35, wherein a third tubular-like housing chamber for receiving a connecting pin which is connected to the one adjusting part of the adjusting equipment is arranged adjacent to the first housing chamber and aligned parallel to the first housing chamber.

38. The adjusting gearing according to claim 22, further comprising a re-enforcing rib which encloses the first housing chamber and the third tubular-like housing chamber, and which is essentially aligned in X-direction and leads to the ends of the second housing chamber.

39. The adjusting gearing according to claim 35, wherein the sides of the second housing chamber are aligned flush and levelled with the end of the first and third housing chamber.

40. The adjusting gearing according to claim 22, wherein the gearing housing consists of plastics.

41. The adjusting gearing according to claim 40, wherein the housing chambers and the bearing points, which are connected to the first and second housing chamber and are formed at the one front faces of the first and second housing chamber, and the re-enforcing rib are connected to each other by adhesion, friction welding, laser welding or laser-melt welding.

42. The adjusting gearing according to claim 40, wherein the housing chambers, the bearing points connected to the first and the second housing chamber and the re-enforcing rib are obtained by die casting or injection molding of a plastic.

43. A method for obtaining and assembling of an adjusting gearing according to claim 22, wherein
one piece gearing housing with two cylindrical housing chambers which are aligned perpendicular to each other and which have bearing points formed on the one front faces with a centrical bore is obtained by die casting or injection moulding of a plastic or by connecting the housing chambers by the means of laser welding, ultrasound welding, vibration welding, adhesion, hot embossing or welding with inductive heating,
a first bearing collar of a drive worm is inserted into the bearing point of the first housing chamber and a first bearing collar of a spindle nut or a screw gear is inserted into the bearing point of the second housing chamber,
a first bearing bush having a cylindrical bush that matches to the internal diameter of the first housing chamber for centering the second bearing collar of the drive worm and a second bearing bush having a cylindrical bush that matches the internal diameter of the second housing chamber for centering the second bearing collar of the spindle nut or the screw gear are inserted into the first and second housing chamber and are mounted onto the second bearing collar of the drive worm or the spindle nut or the screw gear until a play-free mounting of the drive worm or the spindle nut or the screw gear,
and the first and the second bearing bush are connected to the first and second housing chamber by laser welding, ultrasound welding, vibration welding, adhesion, hot embossing or welding with inductive heating.
